(19) United States
(12) Patent Application Publication
(10) Pub. No.: US 2002/0053630 A1
(43) Pub. Date: May 9, 2002

(54) Multi-functional adjustable base for spa umbrella

(76) Inventor: Wanda Yiing Li, Hollywood, FL (US)

Correspondence Address: RAYMOND Y. CHAN, 1050 OAKDALE LANE, ARCADIA, CA, 91006, US

(21) Appl. No.: 10/005,945

(22) Filed: Nov. 7, 2001

(30) Foreign Application Priority Data
Nov. 8, 2000 (CN) 00252781.2

(51) Int. Cl. F16M 13/00

(52) U.S. Cl. 248/519; 248/539

(57) ABSTRACT

A multi-functional adjustable umbrella base includes a base support, a reinforcing support adapted for being mounted onto a spa bathtub or a platform near a spa's edge, and a stem rotary arrangement supported by the base support for selectively rotating the supporting stem of an spa umbrella and for securely locking up any of its movement. The stem rotary arrangement includes an engaging member rotatably supported by the base support and coaxially connected to the supporting stem of the outdoor umbrella so as to selectively rotate the stem of the outdoor umbrella, a locking member connected to the engaging member for selectively locking the engaging member from being rotated, a paddle operatively connected to the locking member via a connecting arm, and a resilient element mounted on the base support and adapted for normally applying an urging force to the connecting member. In order to unlock the locking member, one has to step down the paddle in order to lift up the engaging portion of the locking member so as to disengage it from the engaging member. Then, the user can ready to rotate the supporting stem of the spa umbrella to a desired orientation.

### BACKGROUND OF THE PRESENT INVENTION

1. Field of Invention

The present invention relates to a base, and more particularly to a multifunctional adjustable spa umbrella base in which a user can be able to selectively adjust the orientation of the spa umbrella or retain the spa umbrella in position and mount the umbrella base onto a spa bathtub or any other platform near a spa's edge.

2. Description of Related Arts

By the virtue of advanced technology, the living standard of human beings is becoming higher and higher. Some entertainments, which were not very popular in the past, have become more and more prevalent nowadays. One remarkable example is bathing in Spas. When people are bathing in Spas, they usually need some kinds of umbrella for shading.

Conventional umbrellas are almost not specifically for spa bathing. Of course, one can use a regular beach umbrella for spa bathing. However, such kind of umbrellas usually cannot suit the special environment for spa bathing, i.e. they are difficult, if not impossible, to be substantially supported on the bathtub or on the platform near the bathtub edge. This inevitably incurs inconvenience to the spa bathers and prohibits the use of spa umbrella during spa bathing. And, as a result of this phenomenon, in worse, spa bathers' skin may even be hurt by vigorous sunlight.

Even though a spa bather is able to fix some kind of umbrellas onto a bathtub, the conventional outdoors umbrella usually cannot be rotated. Due to the fact that the direction of sunlight is varying as time goes, the spa bather needs to rotate the umbrella awning in a direction that it can shade the sunlight effectively. Conventional outdoor umbrellas usually comprise a supporting stem rigidly connected to its base and therefore not allowing any rotational movement of the supporting stem with respect to the base. Therefore, if a spa bather wants to rotate the outdoor umbrella in order to change the orientation of the umbrella awning, he/she may need to turn the whole umbrella. However, this may not be absolutely feasible since when he/she turns the umbrella, at the same time, he/she has to make way to remount the umbrella on the bathtub again. Depending on the geometry of the base of the umbrella and/or the environment near the spa, remounting the umbrella is not necessarily successful.

### SUMMARY OF THE PRESENT INVENTION

A main object of the present invention is to provide a multi-functional adjustable base for spa umbrella which can be easily mounted onto a bathtub of a spa or onto a platform near the edge of the spa.

Another object of the present invention is to provide a multi-functional adjustable base for an spa umbrella which allows the stem of the umbrella can be selectively rotated to an desired orientation or locked up in position, while keeping the stability of the outdoor umbrella intact.

Another object of the present invention is to provide a multi-functional adjustable base for a spa umbrella which is simple in structure, easy to operate, and does not require to alter significantly the original shape and structure of the outdoor umbrella.

Accordingly, in order to accomplish the above objects, the present invention provides a multi-functional adjustable base for a spa umbrella comprising:

a base support;

a reinforcing support outwardly extended from the base support and adapted for being mounted onto an external surface;

a stem rotary arrangement, which comprises:

an engaging member rotatably supported on the base support and firmly connected to the supporting stem of the spa umbrella;

a locking member supported on the base support and has an engaging portion adapted for selectively engaging with a bottom portion of the engaging member;

means for selectively engaging and disengaging the engaging member with the locking member; and

a paddle operatively connected to the locking member and adapted for being driven between a locked position and an unlocked position, wherein in the locked position, the locking member is firmly engaged with the engaging member so as to restrict a rotational movement of the engaging member, and wherein in the unlocked position, the locking member disengages with the engaging member so that the engaging member is capable of freely rotating.

### BRIEF DESCRIPTION OF THE DRAWINGS

FIG. 1 is a side view of a multi-functional adjustable base for a spa umbrella according to a first preferred embodiment of the present invention.

FIG. 2 is a sectional side view of the multi-functional adjustable base for a spa umbrella according to the above first preferred embodiment of the present invention.

FIG. 3 is a partially sectional side view of the multi-functional adjustable base for a spa umbrella according to the above first preferred embodiment of the present invention.

FIG. 4 is a partially sectional side view of the multi-functional adjustable base for a spa umbrella according to a second preferred embodiment of the present invention.

### DETAILED DESCRIPTION OF THE PREFERRED EMBODIMENT

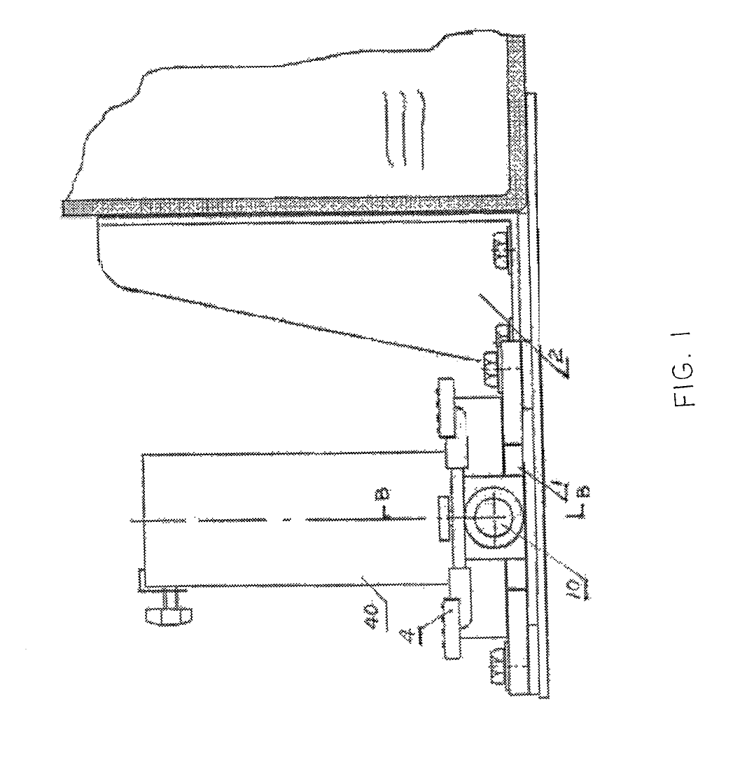

Referring to FIG. 1 of the drawings, a multi-functional adjustable spa umbrella base according to a first preferred embodiment of the present invention is illustrated. According to the first preferred embodiment of the present invention, the multi-functional adjustable umbrella base comprises a base support 1, and a stem rotary arrangement 11 supported by the base support 1 for selectively rotating the supporting stem 40 of a spa umbrella and for securely locking up any of its movement.

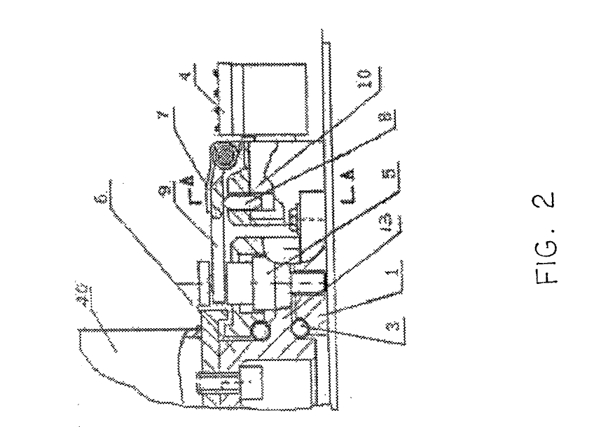

Referring to FIGS. 1-2 of the drawings, the stem rotary arrangement 11 comprises an engaging member 6 rotatably supported by the base support 1 and coaxially connected to the supporting stem 40 of the spa umbrella so as to selectively rotate the stem 40 of the spa umbrella, a locking member 5 connected to the engaging member 6 for selectively locking the engaging member 6 from being rotated, and a pair of paddles 4 operatively connected to the locking member 5 via a connecting arm 9.

The stem rotary arrangement 2 further comprises means for engaging the engaging member 6 with the locking member 5, so as to block up a rotational movement of the engaging member 6 and therefore a rotational movement of the supporting stem 40 of the spa umbrella. The engaging means comprises a plurality of teeth radially and integrally formed on a bottom portion of the engaging member 6 and adapted for engaging with an engaging portion of the locking member 5. Once the engaging member 6 is engaged with the locking member 5, it will be locked up by the locking member 5 and is incapable of rotating.

The stem rotary arrangement 11 further comprises a plurality of rotary supports 3, such as a plurality of steel balls, operatively connected at the bottom portion of the engaging member 6 for rotatably supporting the engaging member 6 on the base support 1.

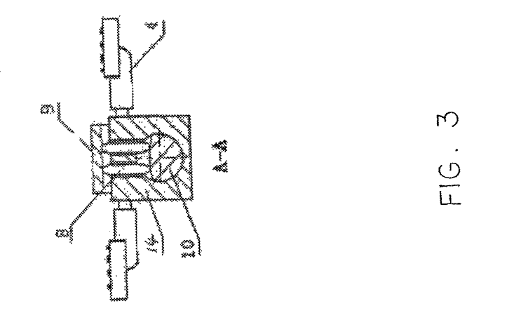

Referring to FIGS. 2-3 of the drawings, the multi-functional adjustable umbrella base further comprises an operation housing 14 supported by the base support 1, an eccentric shaft 10 rotatably mounted in the operation housing 14, a first and a second biasing members 8 upwardly extended from two side portions, namely the first and the second side portion of the eccentric shaft 10 respectively, and adapted for biasing against the connecting arm 9. The connecting arm 9 is communicated with the operation housing 14 and operatively connected with the locking member 5 and is adapted for being lifted up by one of the biasing member 8 inside the operation housing 14.

The pair of paddles 4 is operatively connected to the locking member 5 and adapted for switching the locking member 5 between a locked position and an unlocked position. Normally, the locking member 5 is in locked position and the engaging portion of the locking member 5 is firmly engaged with the bottom potion of the engaging member 6 so as to restrict any movement of the supporting stem 40 mounted thereon. To unlock the locking member 5, one has to step down either the first paddle 4 or the second paddle 4. When the first paddle 4 is stepped downwardly, the first side portion of the eccentric shaft 10 is depressed downwardly, thus making the second side portion of the eccentric shaft 10 and the second biasing member 8 to move upwardly which then biases against and uplifts the connecting arm 9 so as to uplifts the engaging portion of the locking member 5 and disengage the locking member 5 from the engaging member 6. On the other hand, when the second paddle 4 is stepped downwardly, the second side portion of the eccentric shaft 10 is depressed downwardly, thus making the first side portion of the eccentric shaft 10 and the first biasing member 8 to move upwardly which then biases against and uplifts the connecting arm 9 so as to uplifts the engaging portion of the locking member 5 and disengage the locking member 5 from the engaging member 6. It is worth to mention that as a natural consequence of lifting up the second side portion of the eccentric shaft 10 when the first paddle 4 is stepped downwardly, the second paddle 4 is lifted up at the same time. Accordingly, when the second side portion is depressed, the first paddle 4 will be uplifted to its original undepressed locked position. In other words, when one user steps down either one of the paddles 4, the another paddle 4 will be lifted up and the locking member 5 reengages with the engaging member 6 again.

The eccentric nature of the eccentric shaft 10 makes the eccentric shaft 10 remains in position even though the downward stepping force is relieved. This allows the user to walk away the paddle 4 that he/she has depressed, and adjust the supporting stem more conveniently and comfortably. To relock the locking member 5, the user has to depress the uplifting paddle 4 so as to depress the uplifted side portion of the eccentric shaft 10 until the two paddles 4 are at substantially the same height. In doing so, the originally uplifted biasing member 8 is then depressed into the operation housing 14 again and therefore bring down the connecting arms 9. Then, the engaging portion of the locking member 5 is moved downwardly to reengage with the bottom portion of the engaging member 6 so as to relock the supporting stem 40 mounted thereon from any rotation.

The multi-functional adjustable base further comprises a reinforcing support 2 extended outwardly from the base support 1 and adapted for being mounted onto a bathtub of a spa or a platform near the edge of a spa. Whereby, a spa umbrella is capable of being firmly mounted onto a bathtub or a platform neat the edge of a spa. A spa bather can enjoy shading in any orientation of the awning of the umbrella during spa bathing.

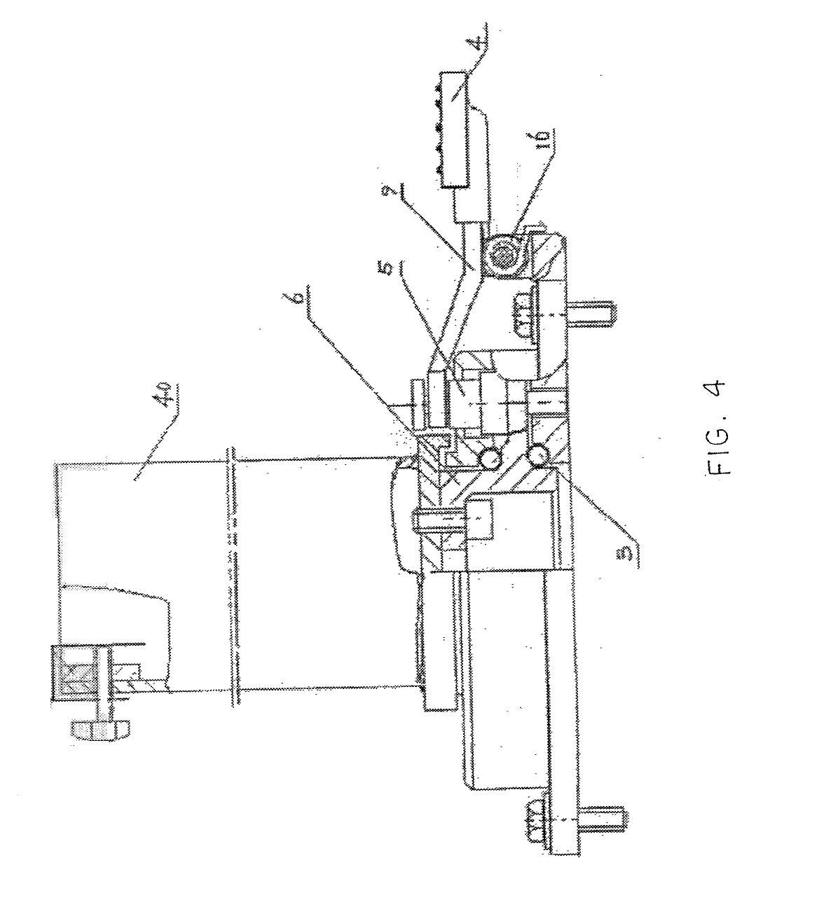

Referring to FIG. 4 of the drawings, the multi-functional adjustable base for a spa umbrella according to a second preferred embodiment of the present invention is illustrated. The second embodiment is similar to that of the first preferred embodiment except the absence of the operative housing 14, the eccentric shaft 10, the pair of the biasing members 8 and one of the two paddles 4 in the above first preferred embodiment. According to the second preferred embodiment of the present invention, the paddle 4′ is operatively connected to the locking member 54′ via a connecting arm 9′, so as to pivotally lift up the locking member 5′ about a pivot from a normal locked position to an unlocked position. In the normal locked position, the locked member 5′ is securely engaged with the bottom portion of the engaging member, so that the rotational motion of the engaging member 6′ is locked up and the supporting stem 40′ of the outdoor umbrella is rigidly mounted on the multi-functional adjustable umbrella base of the present invention. In the unlocked position, the engaging portion of the locking member 5′ is pivotally lifted up by the connecting arm and disengaged from the engaging member 6′. As a result, the engaging member is lifted from any blocking of its rotational movement. In other words, the engaging member 6′ and the supporting stem 40′ mounted thereon are capable of freely rotating.

In order to unlock the locking member 5′ from the normal locked position, one has to step down the paddle 4′ in order to lift up the engaging portion of the locking member 5′ so as to disengage it from the engaging member 6′. Then, the user can be readily to rotate the supporting stem 40′ of the spa umbrella to a desired orientation.

The stem rotary arrangement 11′ further comprises a resilient element 16′ mounted on the pivot of the connecting arm 9′ for normally applying an upward urging force to the connecting member 9′. As a consequence, when the downward stepping force of the user is relieved, the resilient element 7′ will push the connecting member 9′ upwardly, so as to push the paddle upwardly to its original locked position. In other words, the resilient element 7′ automatically depresses the engaging portion of the locking member 5′ to engage with the bottom portion of the engaging member 6′ by means of the connecting arm 9′.

Accordingly, after the user has rotated the supporting stem 40′ of the spa umbrella, he/she can simply relieve his/her downward stepping force and the locking member 5′ automatically returns to its normal locked position. Note that the resilient element 7′ mentioned above is a regular coil spring according to the second preferred embodiment of the present invention, but it can also be any resilient elements that can perform the same function as well.

What is claimed is:

1. A multi-functional adjustable base for spa umbrella having a supporting stem, comprising:
a base support;
a reinforcing support outwardly extended from said base support and adapted for being mounted onto an external surface; and
a stem rotary arrangement, which comprises:
an engaging member rotatably supported on said base support and firmly connected to the supporting stem of the spa umbrella;
a locking member supported on said base support and has an engaging portion adapted for selectively engaging with a bottom portion of said engaging member;
means for selectively engaging and disengaging said engaging member with said locking member; and
a paddle operatively connected to said locking member and adapted for being driven between a locked position and an unlocked position, wherein in said locked position, said locking member is firmly engaged with said engaging member so as to restrict a rotational movement of said engaging member, and wherein in said unlocked position, said locking member disengages with said engaging member so that said engaging member is capable of freely rotating.

2. The multi-functional adjustable base, as recited in claim 1, wherein said engaging means comprises a plurality of teeth radially and integrally formed on a bottom potion of said engaging member and adapted for engaging with said engaging portion of said locking member when said paddle is in locked position.

3. The multi-functional adjustable base, as recited in claim 2, further comprising an operation housing supported by said base support, and wherein said stem rotary arrangement further comprises a connecting arm having a first end portion connected to said engaging portion of said locking member and a second end portion communicated with said operation housing, an eccentric shaft which has a first and a second side portion and rotatably mounted in said operation housing in such a manner that when said paddle is stepped downwardly, said first side portion of said eccentric shaft is rotatably depressed, and said second side portion is rotatably uplifted, and at least a first biasing member extended upwardly from said second side portion of said eccentric shaft, so that when said paddle is stepped downwardly, said biasing member is move upwardly so as to lift up said second end portion of said connecting arm, and lift up said engaging portion of said locking member to disengage said locking member from said engaging member.

4. The multi-functional adjustable base, as recited in claim 3, wherein said stem rotary arrangement further comprises a second paddle operatively connected to said second side portion of said eccentric shaft, and a second biasing member upwardly extended from said first side portion of said eccentric shaft, so that when said second paddle is stepped downwardly, said second side portion of said eccentric shaft is rotatably depressed, uplifting said first side portion of said eccentric shaft and uplifting said second biasing member so as to bias against and uplift said second end portion of said connecting arm and disengage said engaging portion of said locking member from said engaging member.

5. The multi-functional adjustable base, as recited in claim 3, wherein said stem rotary support further comprises a plurality of rotary supports operatively connected to said engaging member for rotatably supporting a rotational movement of said engaging member.

6. The multi-functional adjustable base, as recited in claim 4, wherein said stem rotary support further comprises a plurality of rotary supports operatively connected to said engaging member for rotatably supporting a rotational movement of said engaging member.

7. The multi-functional adjustable base, as recited in claim 1, wherein said stem rotary arrangement further comprises a resilient element supported on said base support, and a connecting arm having a first end connected to said paddle and a second end connected to said engaging portion of said locking member, so that when said paddle is in said locked position, said engaging portion of said locking member is uplifted to disengage with said engaging member, and when said paddle is in said unlocked position, said second end of said connecting arm is depressed to lower said engaging portion of said locking member so as to securely engage said locking member with said engaging member, said resilient element being adapted for applying an urging force to said connecting arm so as to normally retain said paddle in a locked position.

8. The multi-functional adjustable base, as recited in claim 2, wherein said stem rotary arrangement further comprises a resilient element supported on said base support, and a connecting arm having a first end connected to said paddle and a second end connected to said engaging portion of said locking member, so that when said paddle is in said locked position, said engaging portion of said locking member is uplifted to disengage with said engaging member, and when said paddle is in said unlocked position, said second end of said connecting arm is depressed to lower said engaging portion of said locking member so as to securely engage said locking member with said engaging member, said resilient element being adapted for applying an urging force to said connecting arm so as to normally retain said paddle in a locked position.

9. The multi-functional adjustable base, as recited in claim 7, wherein said stem rotary support further comprises a plurality of rotary supports operatively connected to said engaging member for rotatably supporting a rotational movement of said engaging member.

10. The multi-functional adjustable base for an umbrella, as recited in claim 9, wherein said stem rotary support further comprises a plurality of rotary supports operatively connected to said engaging member for rotatably supporting a rotational movement of said engaging member.

11. The multi-functional adjustable base, as recited in claim 9, wherein said resilient element is a coil spring.

12. The multi-functional adjustable base, as recited in claim 10, wherein said resilient element is a coil spring.
